(19) United States
(12) Patent Application Publication
(10) Pub. No.: US 2010/0271320 A1
(43) Pub. Date: Oct. 28, 2010

(54) METHOD AND DEVICE FOR CONTROLLING A SYSTEM

(76) Inventors: Roland Eckl, Munchen (DE); Alois Ferscha, Wien (AT); Stefan Gusenbauer, Schwertberg (AT); Cornel Klein, Oberhaching (DE); Christoph Kuhmünch, Munchen (DE); Asa MacWilliams, Munchen (DE); Jelena Mitic, Munchen (DE); Bernhard Wally, Wien (AT)

Correspondence Address: King & Spalding LLP, 401 Congress Avenue, Suite 3200, Austin, TX, 78701, US

(21) Appl. No.: 12/679,513

(22) PCT Filed: May 20, 2009
(86) PCT No.: PCT/EP2009/056109

§ 371 Date: Jun. 14, 2010

(30) Foreign Application Priority Data
Jul. 21, 2008 (DE) 10 2008 033 963.6

(51) Int. Cl. G06F 3/041

(52) U.S. Cl. 345/173

(57) ABSTRACT

A control device (1) controls a system using at least one control element (3) that can be manually actuated, a function (F) of the system being controllable depending on a position of the control element (3) in a multi-dimensional reference space (2).

### CROSS-REFERENCE TO RELATED APPLICATIONS

This application is a U.S. National Stage Application of International Application No. PCT/EP2009/056109 filed May 20, 2009 which designates the United States of America, and claims priority to German Application No. 10 2008 033 963.6 filed Jul. 21, 2008, the contents of which are hereby incorporated by reference in their entirety.

### TECHNICAL FIELD

The invention relates to a method and a device for controlling a system, using a control element that can be operated manually.

### BACKGROUND

There exists a multiplicity of various and electronically switchable appliances, in which different functions of the appliance can be controlled using switches. Conventional switches primarily feature two possibilities for user interaction. In many cases, a user can operate a switch by pressing or rotating the switch. In the majority of technical appliances, various functions of the appliance are assigned to one or more switches. For example, an appliance can be turned on or off by means of a tumbler switch. In the case of a radio, e.g. the volume is adjusted by means of a rotatable regulator, and in the case of a mixing desk, the volumes of various channels are adjusted by means of dimmer switches. Various types of switches are known. If a tumbler switch is pressed, for example, it remains in its switched state. One example of this is a light switch, which retains the last switched state after manual operation. Buttons are also known which only retain the switched state for as long as they are pressed by the user. One example of this is a bell switch. Regulators which can be moved or rotated along an axis are also known. Regulators likewise retain their switched state after being manually operated. Sliding regulators on a mixing desk are one example of a regulator which can be moved along an axis. Simple rotatable regulators which are rotated about an axis include e.g. volume regulators in the case of audio amplifiers.

The conventional switch elements are manually operated by means of pressing, rotating or sliding by a user. When pressing the switch element, either discrete pressure or continuous pressure can be applied. In the case of discrete pressure, pressure is applied briefly to the switch element and the switch element is then released again. Discrete states can be switched in this way, e.g. on/off. The user can also apply lasting or continuous pressure to the switch element.

Dimmer controls are realized in this way, for example. The rotation of a switch element can also be discrete or continuous. In the case of discrete rotation, a rotary switch is moved from a first rotational position to a different rotational position. One example of this is a rotary regulator for a cooker hob. In the case of continuous rotation of a switch element, there is no provision for positional fixing; i.e. the rotational radius of the switch element is not restricted to individual switching ranges. One example of this is a volume regulator for a stereo system.

The sliding of a switch element can also be discrete or continuous. One example of a discretely switchable sliding switch element is e.g. a heating control with temperature degrees which are adjusted incrementally. One example of a switch element that can be continuously shifted is e.g. a sliding regulator on a mixing desk.

An appliance can feature a multiplicity of different technical functions, respectively associated switch elements or control elements being assigned to the various functions in the case of conventional technical appliances and systems. For example, the volume function in an amplifier of a stereo system is assigned a continuous rotary volume regulator as a control element. The on/off function of the amplifier is assigned a push button or tumbler switch for turning the power supply on or off.

Conventional systems have the disadvantage that, due to the multiplicity of possible different functions of the system, there are many different control elements to be operated, in different ways, by the user. Consequently, the user has to press a control element for one function and rotate or shift the control element for further functions, for example. The greater the number of different functions of the system or the appliance, the more confusing the operation of the system for the user concerned. While the number of functions in an amplifier of a stereo system is still manageable (e.g. on/off, volume and balance), e.g. mixing desks or scene changers for stage equipment already feature a multiplicity of different functions which are difficult for a user to manage.

### SUMMARY

According to various embodiments a method and a device for controlling a system can be provided, which can be utilized intuitively by a user in a simple manner.

According to an embodiment, a control device for controlling a system may comprise at least one manually operable control element, wherein a function of the system can be controlled depending on a position of the control element in a multidimensional reference space.

According to a further embodiment, the multidimensional reference space can be a two-dimensional reference surface. According to a further embodiment, the position of the control element can be formed by an absolute position of the control element in the reference space or a relative position of the control element to a reference point within the reference space, or by a relative position of the control element to at least one other control element within the reference space. According to a further embodiment, the control element in the multidimensional reference space can be graphically represented for its manual operation. According to a further embodiment, the control element can be a manually operable three-dimensional body, which is manually operable in the multidimensional reference space. According to a further embodiment, the three-dimensional body can be manually operable on a two-dimensional reference surface. According to a further embodiment, at least one associated actuator or one associated actuator group can be controlled by the manually operable control element. According to a further embodiment, the actuator can be controlled depending on the position of the control element in the multidimensional reference space. According to a further embodiment, a plurality of control elements which touch each other in the multidimensional reference space can be linked together. According to a further embodiment, According to a further embodiment, the two-dimensional reference surface can be formed by a sensor mat. According to a further embodiment, the sensor mat can be pressure-sensitive. According to a further embodiment, the control element can be a magnetic head. According to a further embodiment, the two-dimensional reference surface can be a touch-sensitive screen, on which the control element is operable as a graphical representation. According to a further embodiment, the manual operation of the control element may cause an absolute or relative position of the control element to be changed. According to a further embodiment, the manual operation of the control element may cause a pressure or a rotary movement to be applied to the control element. According to a further embodiment, the manual operation of the control element may cause an absolute or relative orientation of the control element to be changed in the reference space. According to a further embodiment, the manual operation of the control element may cause the control element to be rotated. According to a further embodiment, each control element may feature a relevant control element identification. According to a further embodiment, the multidimensional reference space may comprise various logical reference sub-spaces, to which at least one function of the system is assigned in each case. According to a further embodiment, the logical reference sub-spaces can be formed by geometric partitions. According to a further embodiment, the logical reference sub-spaces can be selected from a group of predefined reference sub-spaces. According to a further embodiment, the logical reference sub-spaces can be changed relative to time. According to a further embodiment, a real space can be assigned to each logical reference sub-space. According to a further embodiment, a switched state of the control element can be assigned to each logical reference sub-space. According to a further embodiment, the multidimensional reference space can be a two-dimensional reference surface which features an active surface as a first logical reference sub-space, all control elements situated therein activating an associated actuator in each case, and a passive surface as a second logical reference sub-space, all control elements situated therein deactivating an associated actuator in each case. According to a further embodiment, the logical reference sub-spaces can be changed depending on environmental conditions which are detected by sensory means. According to a further embodiment, the position of the control element in the multidimensional reference space can be detected by sensory means.

According to another embodiment, in a method for controlling a system, a function of the system is controlled depending on the position of a manually operable control element in a multidimensional reference space.

According to a further embodiment of the method, the function of the system can be controlled depending on an absolute position of the control element in the multidimensional reference space. According to a further embodiment of the method, the function of the system can be controlled depending on a relative position of the control element to a reference point within the multidimensional reference space. According to a further embodiment of the method, the function of the system can be controlled depending on a relative position of the control element to at least one other control element within the same or within another multidimensional reference space. According to a further embodiment of the method, an associated actuator can be controlled by the control element. According to a further embodiment of the method, the control element can be touched by a finger of a user for the purpose of its manual operation.

According to yet another embodiment, in an appliance an appliance function can be controlled depending on a position of a manually operable control element in a multidimensional reference space.

According to a further embodiment of the appliance, the appliance may comprise a touch-sensitive screen on which at least one manually operable control element is graphically represented, wherein a position of the control element in the multidimensional reference space can be changed after touching the graphically represented control element for controlling the appliance function.

### BRIEF DESCRIPTION OF THE DRAWINGS

In order to explain the essential features of the invention, embodiments of the control device and of the method are described below with reference to the appended figures, in which:

FIG. 1 shows a block schematic diagram of a possible embodiment of the control device;

FIGS. 2A, 2B show various possibilities for manual operation of a control element in the context of the control device;

FIG. 3 shows an exemplary embodiment of the control device with a three-dimensional reference space;

FIG. 4 shows a further exemplary embodiment of the control device with a three-dimensional reference space;

FIGS. 5A-5D show various exemplary embodiments of reference spaces which can be utilized in the context of the control device;

FIGS. 6A-6F show examples of various possibilities for user interaction with switch elements in the context of the control device;

FIGS. 7A-7D show examples of interaction with a switch element in the context of the control device;

FIG. 8 shows an exemplary embodiment of the control device;

FIGS. 9A-9D show user interaction possibilities for manual operation of a switch element in the context of the control device;

FIGS. 10A, 10B show exemplary embodiments of the control device;

FIGS. 11A, 11B show further exemplary embodiments of the control device;

FIG. 12 shows a further exemplary embodiment of a control device;

FIG. 13 shows a further exemplary embodiment of the control device;

FIG. 14 shows a diagram representing various selectable reference spaces which can be utilized in the context of the control device;

FIG. 15 shows a further exemplary embodiment of the control device;

FIGS. 16A, 16B show further exemplary embodiments of the control device;

FIG. 17 shows a further exemplary embodiment of the control device.

### DETAILED DESCRIPTION

The various embodiments provide a control device for controlling a system using at least one control element that can be manually operated, wherein a function of the system can be controlled depending on a multidimensional position of the control element in a multidimensional reference space.

The control device according to various embodiments offers the advantage that it can be used flexibly for the widest variety of functions, all of which can be utilized in a similar manner easily and intuitively by a user.

In the control device according to various embodiments, the position of the control element is preferably used to control non-geometric system functions.

In an embodiment of the control device, the multidimensional reference space is formed by a two-dimensional reference surface.

In an alternative embodiment, the multidimensional reference space is a three-dimensional reference space, in which the position of the control element can be changed.

In an embodiment of the control device, the position of the control element is formed by an absolute position of the control element in the reference space.

In an alternative embodiment of the control device, the position is formed by a relative position of the control element to a reference point of the reference space.

In an alternative embodiment of the control device, the position is formed by a relative position of the control element to at least one other control element within the reference space.

In an embodiment of the control device, the control element in the multidimensional reference space is graphically represented for its manual operation.

In an embodiment, modifiable text is displayed on a control element.

In an embodiment of the control device, the control element is a manually operable three-dimensional body, which can be manually operated in the multidimensional reference space.

In an embodiment of the control device, the three-dimensional body can be manually operated on a two-dimensional reference surface.

In an embodiment of the control device, each manually operable control element is assigned at least one associated actuator or actuator group which is controlled by the control element.

In an embodiment of the control device, the actuator is controlled depending on the position of the control element in the multidimensional reference space.

In an embodiment of the control device, the control elements which approach or touch each other in the multidimensional reference space can be linked together functionally.

In an embodiment of the control device, the two-dimensional reference surface is formed by a sensor mat.

In an embodiment of the control device, the sensor mat is pressure-sensitive and is provided for determining the absolute or relative position of the control element.

In an embodiment of the control device, the control element is formed by a magnetic head.

In an alternative embodiment of the control device, the two-dimensional reference surface is a touch-sensitive screen, on which the control element is graphically represented for its manual operation.

In an embodiment of the control device, the manual operation of the control element is effected by changing the absolute or relative position of the control element.

In an alternative embodiment of the control device, the manual operation of the control element is effected by applying pressure or a rotary movement to the control element.

In a further embodiment of the control device, the manual operation of the control element is effected by changing an absolute or relative spatial orientation of the control element in the multidimensional reference space.

In a further embodiment of the control device, the manual operation of the control element is effected by rotating the control element in the multidimensional reference space.

In an embodiment of the control device, each control element features an associated control element identification, which can be stored.

In an embodiment of the control device, the multidimensional reference space features various logical reference sub-spaces, each of which is assigned at least one function of the system.

In an embodiment of the control device, the logical reference sub-spaces are formed by geometric partitions, e.g. sub-surfaces.

In an embodiment of the control device, the various logical reference sub-spaces can be selected from a group of predetermined reference sub-spaces by a user.

In a possible embodiment of the control device, the logical reference sub-spaces can be changed relative to time.

In a possible embodiment of the control device, each logical reference sub-space is assigned a real object or space.

In an embodiment of the control device, each logical reference sub-space is assigned a switched state of the control element.

In a possible embodiment of the control device, the multidimensional reference space is formed by a two-dimensional reference surface, said two-dimensional reference surface having an active surface as a first logical reference sub-space, wherein all control elements located therein activate the respective associated actuator, and a passive surface as a second logical reference sub-space, wherein all switch elements located therein deactivate the respective associated actuator.

In an embodiment of the control device, the logical reference sub-spaces can be changed depending on environmental conditions that are detected by sensory means.

In an embodiment of the control device, the position of the control element in the multidimensional reference space is detected by sensors.

According to other embodiments, in a method for controlling a system, a function of the system is controlled depending on a position of a manually operable control element in a multidimensional reference space.

In an embodiment of the method, the function of the system is controlled depending on an absolute position of the control element in the multidimensional reference space.

In an embodiment of the method, the function of the system is controlled depending on a relative position of the control element to a reference point within the multidimensional reference space.

In a further embodiment of the method, the function of the system is controlled depending on a relative position of the control element to at least one other control element within the multidimensional reference space.

In an embodiment of the method, an associated actuator is controlled by the control element.

In an embodiment of the method, the control element is touched by a finger of a user for the purpose of its manual operation.

According to yet other embodiments, in an appliance an appliance function can be controlled depending on a position of a manually operable control element in a multidimensional reference space.

In an embodiment of the appliance, said appliance features a touch-sensitive screen on which at least one manually operable control element, whose position in a multidimensional reference space can be changed, is graphically represented.

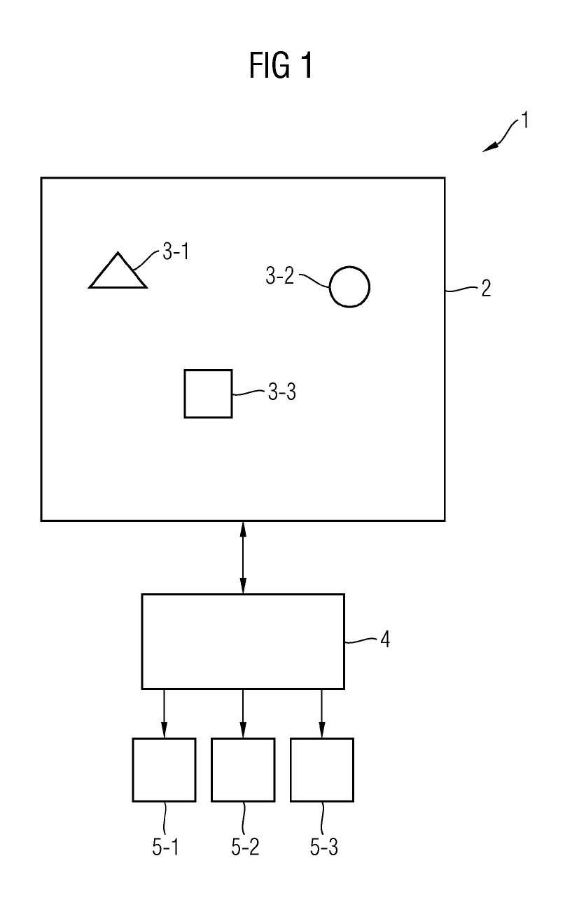

It can be seen from FIG. 1 that the control device 1 according to various embodiments for controlling system functions features a multidimensional reference space 2. The multidimensional reference space 2 can be a two-dimensional reference surface, but can also be a three-dimensional reference space. In the exemplary embodiment of the control device 1 as illustrated in FIG. 1, the multidimensional reference space 2 is formed by a two-dimensional reference surface in which various manually operable control elements 3-1, 3-2, 3-3 are situated. In the context of the exemplary embodiment illustrated in FIG. 1, three switch elements are situated in the two-dimensional reference space 2. The number of switch elements or control elements 3 within the reference space 2 can vary depending on the application. The control elements 3-1, 3-2, 3-3 can be manually operable three-dimensional bodies which can be operated in the reference space 2. In an alternative embodiment, the control elements 3-1, 3-2, 3-3 in the reference space 2 are represented graphically for their manual operation. For example, control elements 3 are represented on a touch-sensitive screen of an appliance.

The control device 1 according to various embodiments features a data processing unit 4 which controls associated actuators 5-1, 5-2, 5-3 depending on positions of the control elements 3-1, 3-2, 3-3 in the reference space 2.

In a possible embodiment, each control element 3-i is assigned an associated actuator 5-i. In an alternative embodiment, one control element 3 can simultaneously control a plurality of actuators 5.

The actuator 5 executes a function of a technical system or an appliance. The actuators 5 can be any chosen actuators, e.g. loudspeakers, lighting equipment or engines. In the context of the control device 1 according to various embodiments, a function of the appliance or of the system is controlled depending on a position of a control element 3 in the multidimensional reference space 2.

In an embodiment, the position of the control element 3 is formed by an absolute position of the control element in the reference space 2. For example, the function is controlled depending on spatial coordinates of the control element 3 in the reference space 2.

In an alternative embodiment, a function is controlled depending on a relative position of the control element 3 to a reference point of the reference space 2. For example, reference points or control terminals can be provided in the reference space, wherein a control element 3 can move closer to the reference point or move away from the reference point. The function is then controlled depending on the distance between the control element 3 and the reference point within the reference space 2.

In a further embodiment of the control device 1, a function is controlled depending on a relative position of the control element 3i to at least one other control element 3 within the reference space 2. A spatial proximity between control elements 3-i, 3-j can express, for example, a functional relationship and shared attributes. Similar switched states in a shared environment can also be provided.

In a possible embodiment of the control device 1, control elements 3 which are very close or touch each other in the multidimensional reference space 2 can be functionally linked.

For example, if the control element 3-1 controls a function F1 and the control element 3-2 controls a function F2, in a possible embodiment, after the two control elements 3-1, 3-2 touch in the reference space 2, both control elements 3-1, 3-2 can control both functions F1, F2.

The control elements 3-1, 3-2, 3-3 as illustrated in FIG. 1 can be inserted in the reference space 2 or generated in the reference space 2 by a user, and also removed or deleted from the reference space 2 by a user. If the control elements 3 are physical three-dimensional objects, e.g. magnetic buttons, a control element 3 belonging to a user can be carried by the user and inserted into the reference space 2 or placed there by the user.

In an embodiment, each control element 3 features an associated control element ID, e.g. a control element identification number.

In a possible embodiment, after operation of the manually operable control element 3, the user can remove the control element 3 from the reference space 2 again or delete the graphical symbol of the represented control element 3.

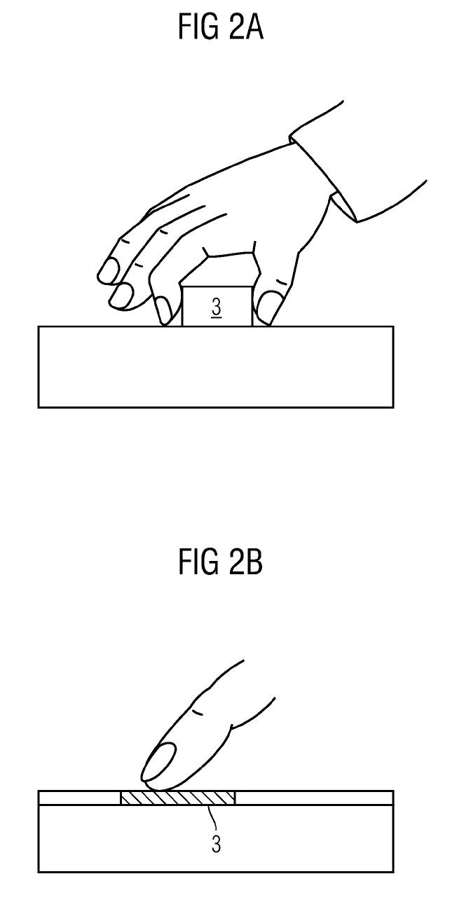

FIGS. 2A, 2B show various possibilities for operating a control element 3 in the context of the control device 1 according to various embodiments. In the embodiment illustrated in FIG. 2, the control element 3 is formed by a three-dimensional body which can be manually operated by the hand of a user, e.g. shifted or rotated on a surface.

In the embodiment illustrated in FIG. 2B, the control element 3 is represented graphically for its operation in the reference space 2. For example, a symbol of the control element 3 is represented on a screen surface of a touch-sensitive screen. By touching the control element 3 with a finger, a user can control a function by means of manual operation, i.e. by changing a position of the control element 3 in the multidimensional reference space.

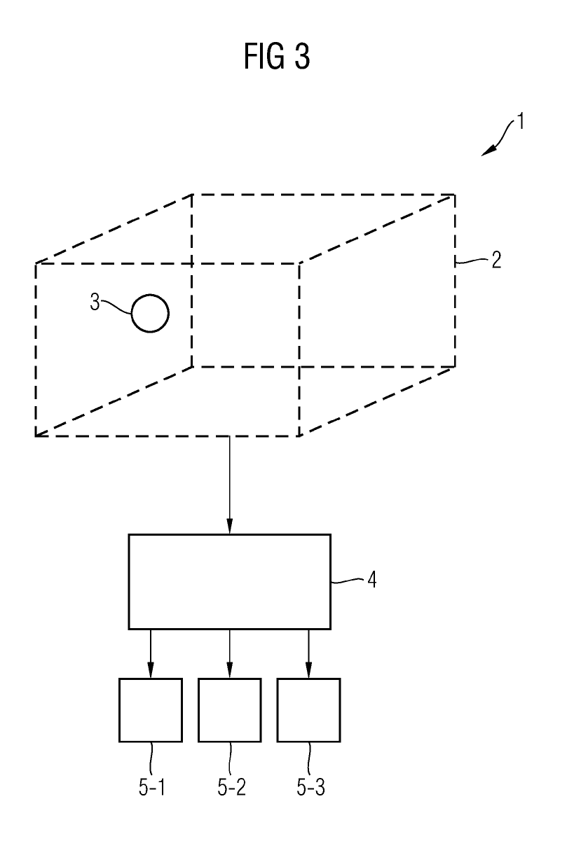

FIG. 3 shows a further exemplary embodiment of an control device 1. In the exemplary embodiment illustrated in FIG. 3, the multidimensional reference space 2 is a three-dimensional reference space in which a control element 3 is situated. A function of the system is controlled depending on the position of the control element 3 in the three-dimensional reference space 2. In this case, the position can again be formed by the absolute position of the control element 3 in the reference space 2, by a relative position of the control element 3 to a reference point within the reference space 2, or by a relative position of the control element 3 to at least one other control element within the reference space 2.

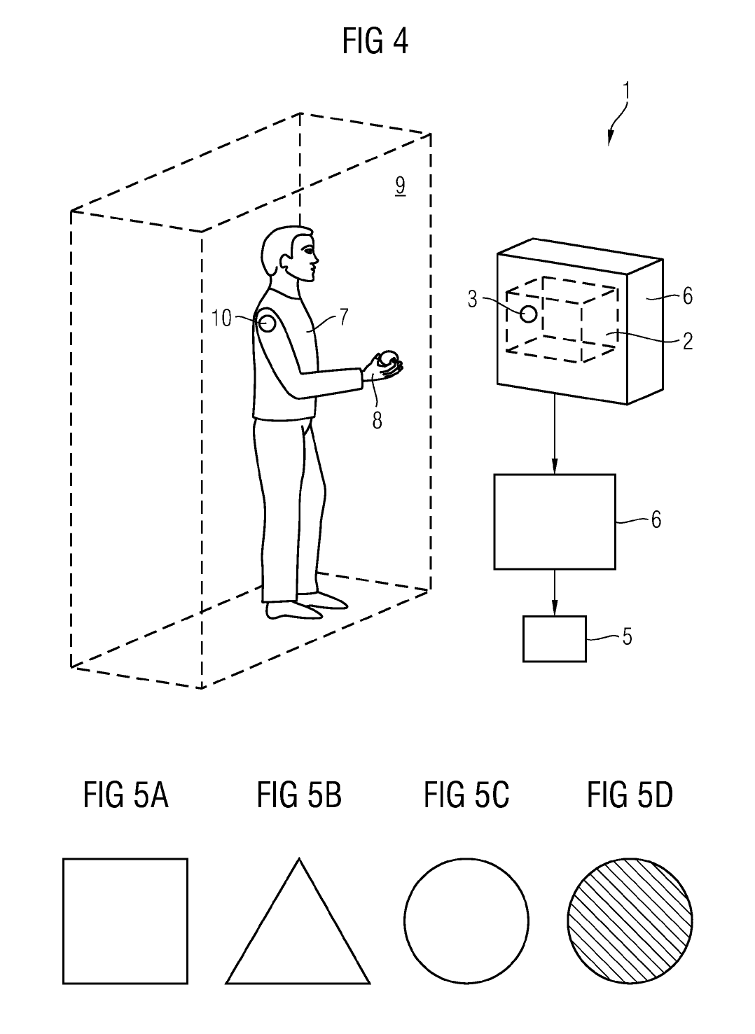

FIG. 4 shows a further exemplary embodiment of the control element 1. In this exemplary embodiment, the multidimensional reference space 2 is likewise formed by a three-dimensional reference space, in which a control element 3 is situated. In the case of the exemplary embodiment illustrated in FIG. 4, the three-dimensional reference space 2 is represented optically on a screen 6. Using an electronic control glove 8 and a wireless interface, for example, a user 7 can communicate with the data processing unit 4 and manually operate the control element 3 in the three-dimensional reference space 3. As a result of the three-dimensional movement of the controlling glove 8, the control element 3 is moved in the three-dimensional reference space 2, i.e. moved translationally or rotated. A function of the system, e.g. an actuator 5, can be controlled depending on the absolute or relative position of the control element 3 in the three-dimensional reference space 2.

In an alternative embodiment, the three-dimensional reference space 2 and the control element 3 contained therein are not visually displayed to the user 7 via a screen, but by means of a helmet which comprises a display and is worn by the user 7, or by means of eyeglasses which are worn by a user 7. The data processing entity 4 can be a computer comprising one or more microprocessors, which has a wireless interface by means of which a user can transfer control signals for the purpose of operating the control element 3.

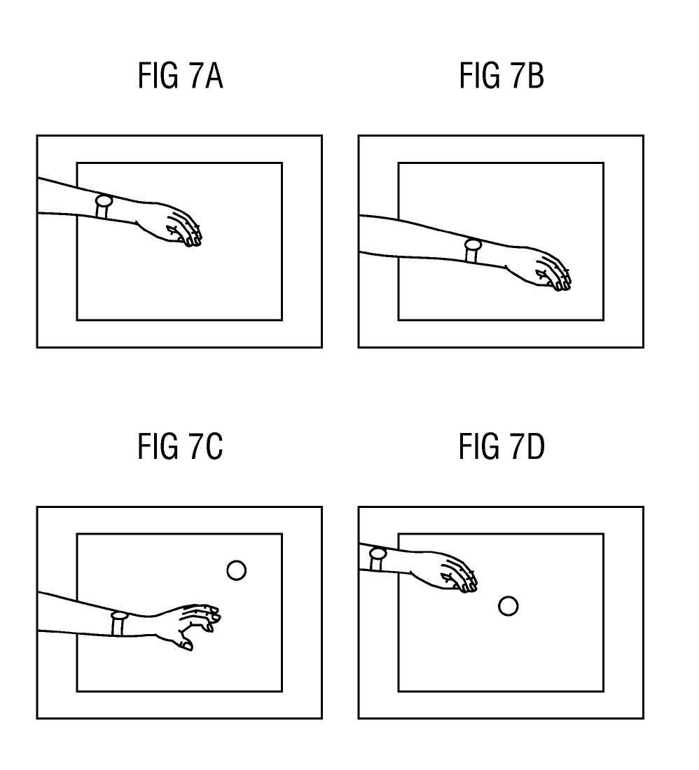

In a further embodiment of the control element, the user 7 moves in a real space 9, which is represented as a three-dimensional reference space 2 on the display 6 shown in FIG. 4. A tag 10 which can be detected by sensory means is located on the user 7 and is represented as a control element 3 in the three-dimensional reference space 2 on the display 6. When the user 7 moves in the real reference space 9, the absolute or relative position of the tag 10 worn by the user 7 changes within the real reference space 9. The change of the absolute or relative position of the tag 10 is detected by sensory means and transformed into a corresponding change of the control element 3 within the multidimensional reference space 2, said change being visible to the user 7. If the user 7 is wearing a helmet which incorporates a display 6, for example, the actual movement of the user within the real reference space 9 can be visually confirmed by the user as a movement of the control element 3 within the multidimensional reference space 2. Depending on the position of the user 7 within the real reference space 9, or depending on the position of the control element 3 within the three-dimensional reference space 2, a function F of the system is then controlled. If the user 7 in the exemplary embodiment illustrated in FIG. 7 moves rightwards, for example, an actuator 5 is turned on, while the actuator 5 is turned off if the user 7 moves leftwards within the real space 9. If the user 7 moves forwards within the space 9, for example, the brightness of a light source can be increased, while the brightness of a light source is decreased if the user 7 moves backwards within the space 9.

In a further embodiment, the user 7 wears e.g. a control glove 8 and a position tag 10, a first control element 3 being operated via the control glove 8 and another control element 3 being controlled depending on the position of the user 7 within the space 9. In a further embodiment, the user 7 wears a plurality of position tags 10 on various limbs, e.g. a position tag 10 on the left arm and a further position tag 10 on the right arm, by means of which various control elements 3 can be controlled within the multidimensional reference space 2. In the same way, the user can also wear a first control glove 8 on the left hand and a second control glove 8 on the right hand for the purpose of controlling various control elements 3 within the multidimensional reference space 2.

FIGS. 5A, 5B, 5C, 5D show various exemplary embodiments for possible multidimensional reference spaces.

FIG. 5A shows a rectangle or square as a possible two-dimensional reference space for the movement or operation of control elements 3.

FIG. 5B shows a triangle as a two-dimensional reference space 2.

FIG. 5C shows a circle as a two-dimensional reference space 2.

FIG. 5D shows a sphere, whose surface forms a three-dimensional reference space 2.

It is evident from the exemplary embodiments illustrated in FIG. 5 that the reference space 2 can assume different geometric shapes, which can be adapted to the application concerned. Various three-dimensional shapes are also possible for a three-dimensional reference space 2, e.g. cuboids, tetrahedrons, spheres, pyramids, etc.

In a possible embodiment of the control system 1, the surface of the reference space 2 can be equipped with semantic information data. This semantic information can be visualized by means of various colors, images, grid patterns or divisions of the reference space 2. In a two-dimensional reference space 2, for example, the user can be shown an image on a display on which various objects are represented. The user can then, by manual operation of a control element 3, change its position relative to the visualized object, thereby controlling a function of the system. For example, a city map of a city can be displayed on a touch-sensitive display 6, on which the user manually operates a control element 3 that is graphically represented. For example, a user can place a control element 3 on a city building which is represented on the city map, wherein a desired switching function relating to the relevant building is controlled by the user as a result of operating the control element 3 that has been placed.

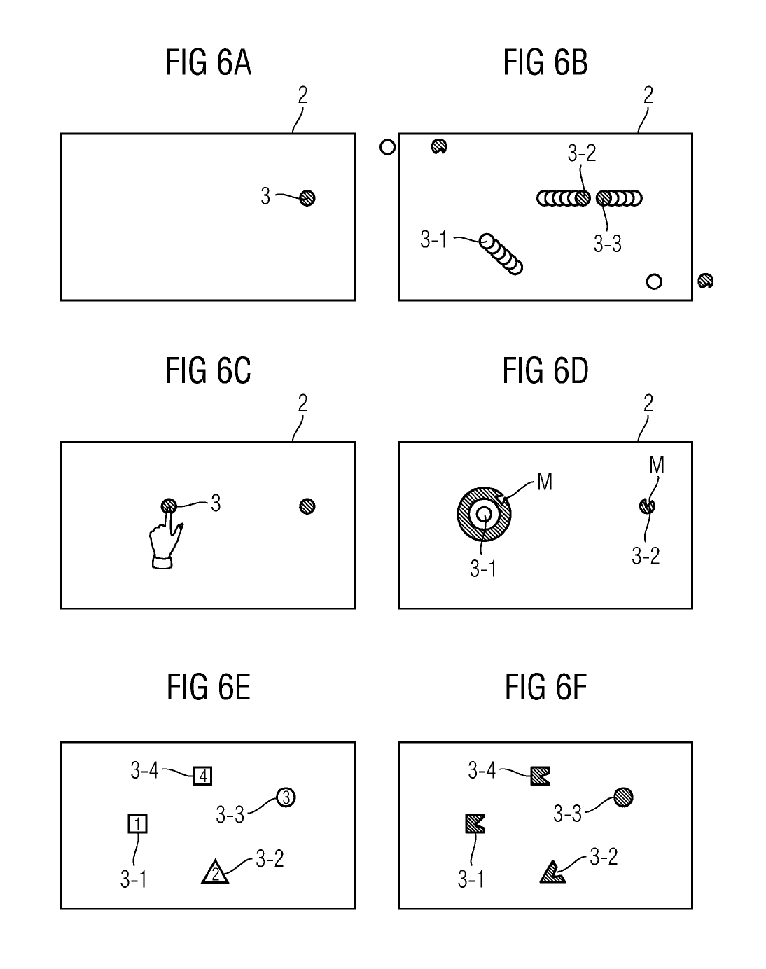

FIGS. 6A to 6F show examples of various possibilities for user interaction with a manually operable control element 3.

As illustrated in FIG. 6A, a function F of the system can already be controlled by placing or inserting or generating a control element 3 within a reference space 2. For example, an associated actuator 5 is activated by placing a control element 3 in the reference space 2.

Furthermore, as illustrated in FIG. 6B, a function F of the system can be controlled by a positional change of control elements 3. In this case, the function F can be controlled depending on an absolute position of the control element 3 or a relative position of the control element. In the example illustrated in FIG. 6B, for example, a first function F1 is controlled depending on the absolute position of the control element 3-1 within the two-dimensional reference space. The relative position of the control element 3-i to another control element 3-j within the reference space 2 can also play a part. For example, the two control elements 3-2, 3-3 are moved towards each other in FIG. 6B. In a possible embodiment, the impending collision of the two control elements 3-2, 3-3 is identified and a corresponding control function is derived therefrom.

In a possible embodiment, functional linking of the associated functions F1, F2 can be effected as a result of two control elements 3i, 3j touching, for example. If the two control elements 3-2, 3-3 illustrated in FIG. 6B touch each other, for example, a possible embodiment then allows both control elements 3-i, 3-j also to execute or control the functions of the other control element respectively. Other functional links are also possible, e.g. an exchange of the controlled functions F1, F2 of the two control elements 3i, 3j touching each other.

A further possibility for interacting with the control element 3 involves a user pressing the control element 3, for example, as illustrated in FIG. 6C.

A further interaction possibility involves a user changing a spatial orientation of the control element 3 in the reference space 2, and control function F being derived therefrom. As illustrated in FIG. 6D, the control elements 3-1, 3-2 in each case feature a marking M which indicates the spatial orientation of the control element 3 in the reference space 2. A user can select a control element 3 by touching it, for example, and then change the spatial orientation of the control element 3 within the reference space 2 by rotating the marking M. The control elements can feature various sizes and shapes in this case, as illustrated in FIG. 6D. The size of the control element 3 can reflect the significance of the associated actuator 5 in this case. For example, a control element 3 which is represented as large in the reference space 2 controls a large or powerful actuator 5, while a control element 3 which is represented as small in the reference space 2 controls a small or low-power actuator 5. For example, the control element 3-1 shown in FIG. 6D controls a rotatable spotlight having a high luminous power, while the smaller control element 3-2 illustrated in FIG. 6D controls a rotatable spotlight having modest luminous power. The user can intuitively recognize the effects of a control process by virtue of the size of the control element 3 that is represented.

In an embodiment of the control device 1, each control element 3 is uniquely identifiable for the user. For example, as illustrated in FIG. 6E, each control element features an individual unique symbol which allows the user to distinguish the control elements 3 from each other. IN the case of the example illustrated in FIG. 6E, the first control element 3-1 is represented by a square, the second control element 3-2 by a triangle and the third control element 3-3 by a circle. The fourth control element 3-4 is likewise a square. In a possible embodiment, the shape of the control element tells the user about the associated controlled function F. In the case of the example illustrated in FIG. 6E, the control elements 3-1, 3-4 control a similar function F within the system, this being expressed by the similar shape of the associated control element. As illustrated in FIG. 6F, the various control elements 3 having the different control element shapes can also feature markings in each case for rotating the control elements.

In the control device 1 according to various embodiments, the positions of the control elements 3 in the multidimensional reference space 2 are analyzed in various ways to derive control signals. On one hand, the current relative or absolute position of the control element 3 can be analyzed for the purpose of directly controlling an associated actuator 5. On the other hand, a logical combination of positions of the control elements 3 in the multidimensional reference space 2 can also be used to control functions F of the system. If a control element 3 is placed at a specific position within the reference space 2, for example, each further interaction with the control element 3 at this position, e.g. rotating or pressing it, results in a switching function of the actuator that is linked to this position.

A permanent functional link can be realized between a control element 3 and an actuator. According to various embodiments, an actuator 5 that is to be controlled can be selected by placing a control element 3 at a location in the reference space 2, said location being associated with the actuator. The control element 3 can be removed from the reference space 2 again subsequently. In a possible embodiment, the association between the control element 3 and the actuator 5 which is linked thereto can be retained even after the control element 3 is removed from the reference space 2.

In a possible embodiment of the control device 1, a plurality of actuators 5 can be controlled simultaneously by means of simultaneous manual operation of a plurality of control elements 3. In a domestic environment, for example, synchronous control of a lighting scenario and an air-conditioning scenario can take place within a living room. The number of control elements 3 can be changed relative to time. Using the control device 1 according to various embodiments, it is therefore possible not only to implement a direct mapping of the position of the control element 3 onto an associated actuator 5, but also to realize so-called shortcuts, i.e. a control element 3 can control various actuators 5 simultaneously. A switch position of a control element 3 in the reference space can be checked easily.

In a possible embodiment of the control device 1, provision is made for a so-called docking function, wherein control elements 3 which touch each other within the reference space 2 remain adhered to each other and are then operable in combination, e.g. shifted jointly within the reference space 2. This allows rapid and simple operation of associated control elements 3.

Since each control element can have a number of degrees of freedom within the multidimensional reference space 2, a plurality of functions F or properties of an appliance can be controlled simultaneously using a control element 3 in an embodiment of the control device 1. By moving a control element 3 in a two-dimensional reference space 2, for example, the horizontal and vertical positional change of the control element 3 can be used to change two adjustable properties of an appliance simultaneously. For example, the volume of an actuator 5 can be reduced or increased with reference to a horizontal shift of the control element 3, and a pitch can be modulated with reference to the vertical positional change of the control element 3.

By adding control elements 3 into the reference space 2, it is possible to extend the number of functions F that can be controlled. In a possible embodiment, the control elements 3 can be three-dimensional objects from everyday life. For example, refrigerator magnets can be used as control elements 3. In a possible embodiment, the three-dimensional control elements 3 that are used can be purely passive control elements, such as e.g. magnetic heads. In an alternative embodiment, the three-dimensional control elements 3, which can be placed e.g. on a two-dimensional reference surface 2 and moved there, for their part feature an electronic circuit that can communicate with an associated actuator 5 via a wireless interface.

In a possible embodiment, the data processing unit 4 of the control device 1 features a readout logic and a supervisory logic.

The readout logic can be a software module which extracts the various switched states or the positions of the control elements 3 in the multidimensional reference space 2. The readout logic ensures the interchangeability of various types of control element 3, since the specific details relating to the control of the reference space 2 and the readout of the switched states, for example, are implemented in the readout logic. This means that other applications are not dependent on whether the reference space 3 or switching space reports the position of the control elements 3 or switch elements, or whether the control elements 3 report their relevant position themselves.

In a possible embodiment, the data processing device 4 additionally features a supervisory logic which analyzes the data of the readout logic. In this case, the supervisory logic converts the switched states of the control elements 3 into control information data for the various actuators 5. The control information data or control signals are forwarded to the associated actuators 5 via a wire-based or wireless interface.

The actuators 5 can be electrically or electronically controllable technical appliances. The control element 3 supplies information data, which is forwarded from the data processing system 4 to the relevant actuator 5 via wireless or wire-based communication channels such as KMX, DMX or Ethernet, for example. If the actuator 5 itself does not have sufficient processing power to analyze or interpret the supplied control information, a possible embodiment provides for the intermediate connection of an adapter. This adapter interprets the received control information and converts this into e.g. an on/off signal for the actuator 5.

FIGS. 7A to 7D show a simple exemplary embodiment of the control device 1. In this embodiment, the multidimensional reference space 2 is formed by a two-dimensional reference surface. This two-dimensional reference surface 2 is a pressure-sensitive sensor mat on which various sensor points are distributed in a predetermined grid pattern, providing sufficiently precise resolution to recognize control elements 3 that are used. In the context of this simple embodiment, the control elements 3 are formed by magnetic heads which can be placed on the sensor mat 2. The extent of the magnetic heads ensures that at least two sensor points on the sensor mat are occupied by a magnetic head which is placed thereon. In this case, the magnetic force of attraction produced by the magnetic heads is analyzed by the pressure-sensitive sensor mat in order to determine the position of the control elements 3.

As illustrated in FIG. 7A, a manually operable magnetic head as a control element 3 is placed on a sensor mat as a two-dimensional reference surface 2. The control element 3 thus placed is then shifted manually on the sensor mat as shown in FIG. 7B. FIG. 7C shows a plurality of control elements 3 shifting jointly on the sensor mat. FIG. 7D shows a further control element 3 being added into the reference space 2 by placing a magnetic head onto the sensor mat.

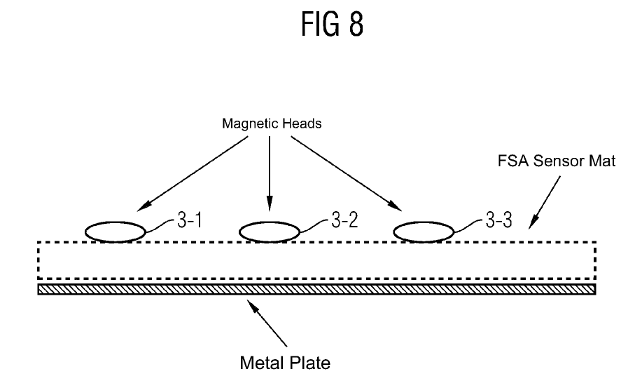

FIG. 8 shows a sectional view through a sensor mat from the embodiment illustrated in FIG. 7. It can be seen in FIG. 8 that magnetic heads 3-1, 3-2, 3-3 as control elements 3 are placed onto a sensor mat on whose underside is situated a metal plate.

In an alternative embodiment, the control elements 3 are not represented by physical objects as illustrated in FIG. 8, but by graphical symbols which are displayed on a touch-sensitive screen and can be operated by a user via a graphical user interface. Control elements 3 can be realized using interactive flash modules, for example. Such control elements 3 offer various user interaction possibilities. In this case, each control element 3 is preferably uniquely identifiable.

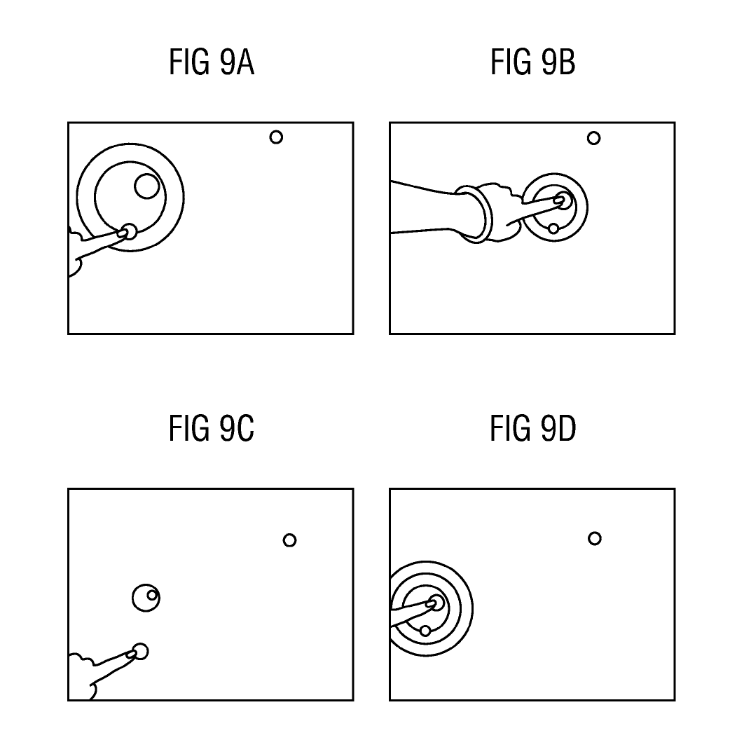

As illustrated in FIG. 9A, a control element 3 can be rotated in the reference space 2, wherein an orientation of the control element 3 in the reference space 2 can be queried for the purpose of controlling a function F. Furthermore, the size of a control element 3 can be changed by means of manual operation as illustrated in FIG. 9B. A further control element 3 can be added to the reference space 2 by means of manual operation, as illustrated in FIG. 9C. Each generated or existing control element 3 can be moved or shifted within the reference space 2, as illustrated in FIG. 9D. In the embodiment of the control elements 3 as illustrated in FIG. 9, these comprise various symbols which serve as access points for the user. The orientation of the control element 3 can be changed at a first access point, for example, while another access point is used to adjust the size of the control element 3. In a possible embodiment, the size of the control element 3 can be directly linked to a function F or a physical property of an actuator 5. If the actuator 5 is a light source, for example, the intensity of the emitted light can be directly proportional to the size or surface of the associated control element 3, for example.

The control device 1 and the method for controlling a system according to various embodiments can be used in a versatile manner. For example, the control element according to various embodiments is suitable for multi-media systems, in particular for controlling film, music and light functions.

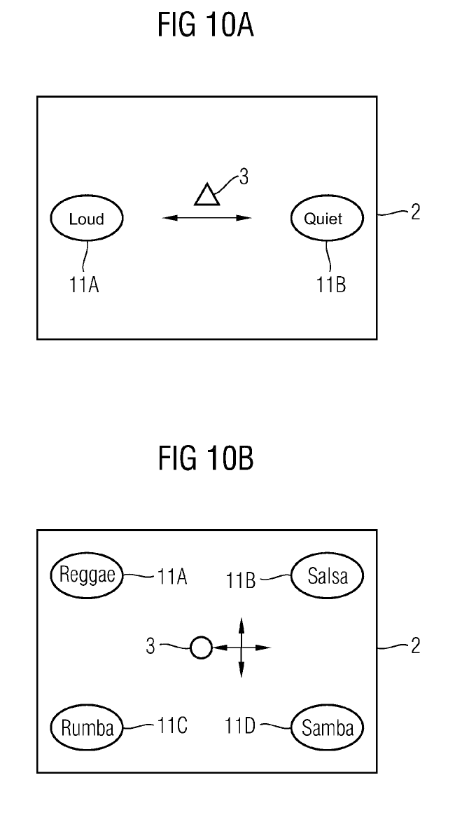

FIG. 10A shows a simple exemplary application for the control device 1. In this embodiment, the multidimensional reference space 2 is formed by a two-dimensional reference surface on which two reference points or reference terminals 11A, 11B are provided. A control element 3 can be shifted between the two reference terminals 11A, 11B in the reference space 2. The smaller the distance between the shiftable control element 3 and the reference terminal 11A within the reference space 2, the higher the volume of the associated loudspeaker 5. The closer the control element 3 moves to the reference terminal 11B, the lower the volume of an associated loudspeaker 5. In the embodiment illustrated in FIG. 10A, a control element 3 moves between two reference terminals 11A, 11B. In the exemplary application illustrated in FIG. 10B, a control element 3 can be moved between four reference terminals 11A to 11D within the two-dimensional reference space 2. In the exemplary application illustrated in FIG. 10B, each reference terminal 11A to 11D represents a specific music rhythm, namely reggae, salsa, samba or rumba. The more closely the control element 3 is positioned to a reference terminal 11, the greater the proportion of the particular rhythm of the reference terminal in the acoustic signal that is output by the actuator 5. In the case of the embodiment illustrated in FIG. 10B, therefore, an output signal is mixed together from various stored signals depending on the position of the control element 3 in the reference space 2, each stored signal being assigned to a reference terminal 11A to 11D.

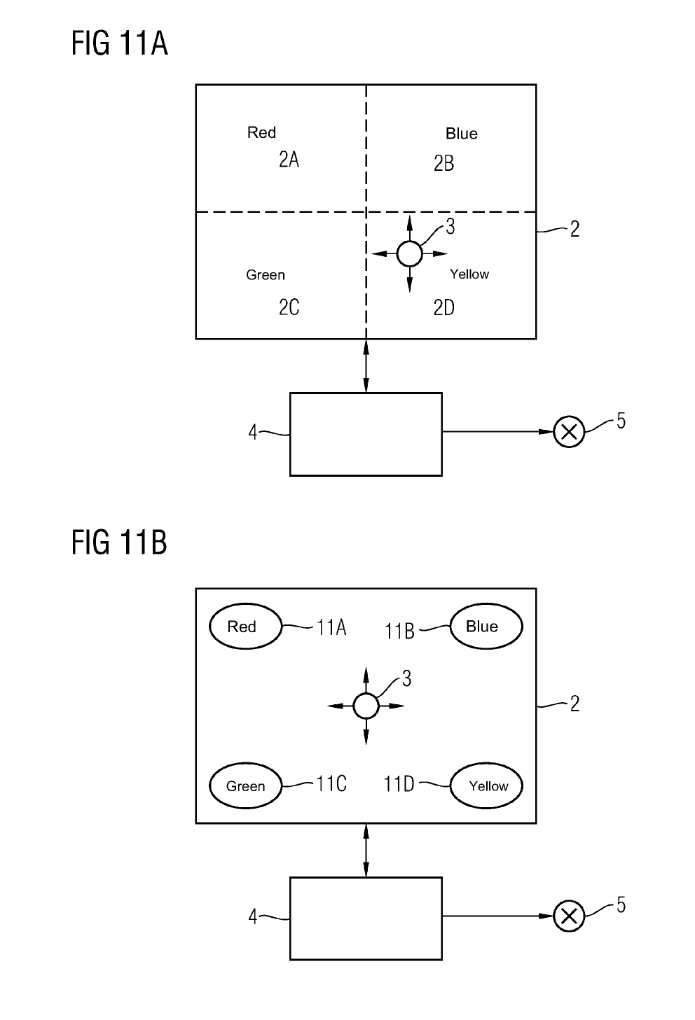

The FIGS. 11A, 11B show further exemplary embodiments of the control device. In the case of the exemplary embodiment illustrated in FIG. 11A, an actuator 5 comprises a light source which can emit light of different colors. A control element 3 can be shifted in a two-dimensional reference space 2. The reference space 2 comprises a reference surface which is divided into various sub-surfaces 2A-2D. In the case of the exemplary embodiment illustrated in FIG. 11, the reference space 2 has four logical reference sub-spaces or reference surfaces 2A, 2B, 2C, 2D. Each logical reference sub-surface is assigned a color. There are spatial boundaries between the various logical reference sub-spaces 2A-2D, wherein a control element 3 performs a function change when the spatial boundaries are crossed, meaning that the color emitted by the actuator 5 changes in the exemplary application. In the situation illustrated in FIG. 11, the control element 3 is situated in the logical reference sub-space 2D of the reference surface 2, and the associated actuator 5 of the control element 3 emits yellow light into the environment. If the control element 3 is shifted into e.g. the logical reference sub-space 2C as a result of manual operation by a user, the light source 5 emits green light.

FIG. 11B shows an alternative implementation, in which the various colors of the light source 5 are assigned various reference terminals 11A to 11D within the reference space 2. If the control element 3 is shifted into the vicinity of the reference terminal 11D, for example, the light source 5 shines yellow. If the control element 3 is then shifted from the yellow reference terminal 11D towards another reference terminal, the proportion of the yellow light decreases and the proportion of the other color increases.

In the context of embodiments shown in FIGS. 11A, 11B, the transition from one color to the other can be gradual or abrupt.

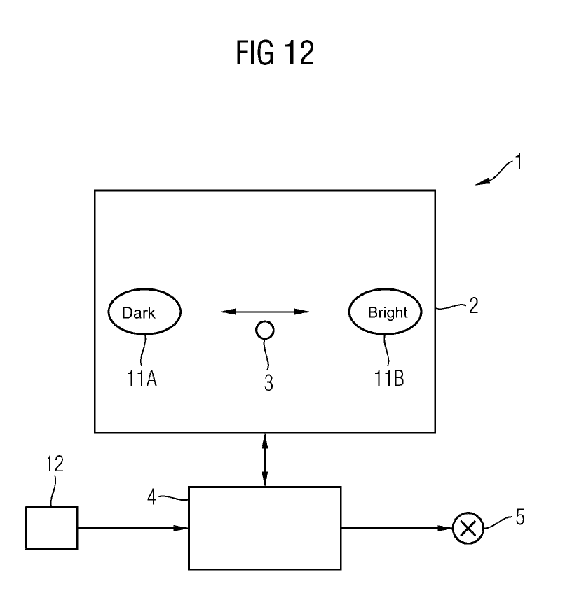

FIG. 12 shows a further exemplary embodiment of the control device 1. In the embodiment illustrated in FIG. 12, the data processing device 4 of the control device is not only connected to an entity for determining the position of a control element 3 within a reference space 2 and to an associated actuator 5, but also to at least one sensor 12 which detects environmental conditions. In the context of the exemplary application illustrated in FIG. 12, a control element 3 is moved between two reference terminals 11A, 11B within the two-dimensional reference space 2, wherein each reference point or reference terminal 11A, 11B corresponds to a setting of an associated actuator 5, which is represented by a light source in the present example. The closer the control element 3 is moved to the reference terminal 11B as a result of manual operation, the brighter the associated lamp 5 shines. If the control element 3 is shifted towards the reference point 11A, the luminosity of the lamp 5 decreases accordingly. In the case of the embodiment illustrated in FIG. 12, the data processing device 4 also reads the data from a sensor 12. This sensor 12 detects the environmental brightness, for example. If it is daytime, for example, and an associated space in a building is already relatively bright due to the daylight, a lamp 5 situated in said space need only shine relatively weakly in order to achieve the brightness desired by the user, said brightness being controlled by the user by means of moving the control element 3 towards the brightness terminal 11B. If the control process takes place during the night and there is no daylight, the light source 5 must emit light at considerably higher light intensity in order to achieve the same brightness in an associated space. The data processing device 4 can therefore also analyze sensor data of a sensor 12, in addition to the control information derived from the position of the control element 3, for the purpose of controlling actuators 5. It is thus possible to save energy, for example, and to achieve a more accurate control result corresponding more accurately to a desired setting value.

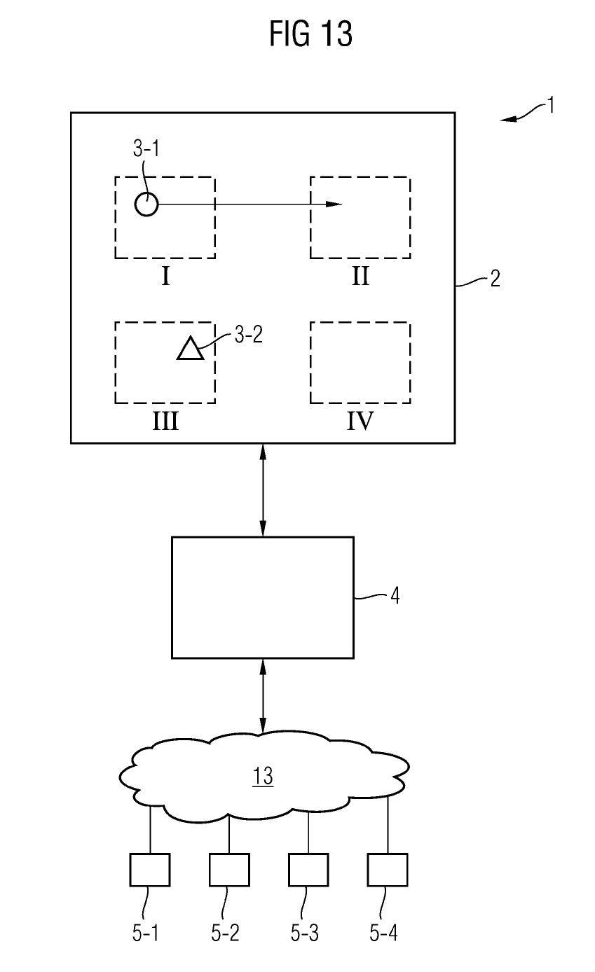

FIG. 13 shows a further exemplary embodiment of the control device 1. In the exemplary embodiment illustrated in FIG. 13, the multidimensional reference space 2 comprises a two-dimensional reference surface, e.g. a touch-sensitive touch screen. In the context of the embodiment illustrated in FIG. 13, semantic information is additionally represented on the touch screen or touch-sensitive display. In the simple exemplary embodiment illustrated in FIG. 13, the layouts of a plurality of buildings I to IV are shown by broken lines in the two-dimensional reference space. These four buildings might be situated on a factory site, for example. As a result of placing a control element 3-1 in the broken-marked reference sub-space I, a function associated with the building I is activated. For example, as a result of placing or shifting the control element 3-1 into the broken-marked surface of the building I, the light in the whole building I is turned on. The control element 3-1 can then be shifted by manual operation into the broken-marked region of the building II. As a result of this manual operation, the light in the building I is turned off and the light in the associated building II is activated. Another control element 3-2 can be used to control a different function, e.g. activate or deactivate an alarm system. In the exemplary embodiment illustrated in FIG. 13, various actuators 5-1 to 5-4 in the various buildings I to IV are controlled via a data network 13. The data processing unit 4 can also receive sensor data via the network 13 from sensors 12 which are arranged decentrally.

FIG. 14 shows a diagram illustrating a further exemplary embodiment of the control device 1.

In this embodiment, the control device 1 features not just one reference space 2, but a plurality of reference spaces 2-1, 2-2, 2-3 which are arranged one on top of the other in a layered manner and can be selected by a user. Each of these reference spaces 2-1 to 2-3 can in turn be divided into various logical reference sub-spaces. The logical reference sub-spaces are formed by two-dimensional surfaces within a selected reference space 2-i, for example. These logical reference sub-spaces can also be selected e.g. from a group of predetermined sub-spaces. Each logical reference sub-space within a reference space 2 can be assigned to a real space or a real object.

In a possible embodiment, the extent of the logical reference sub-spaces can be changed depending on environmental conditions which are detected by sensory means. A switched state of a control element 3 can be assigned to each logical reference sub-space.

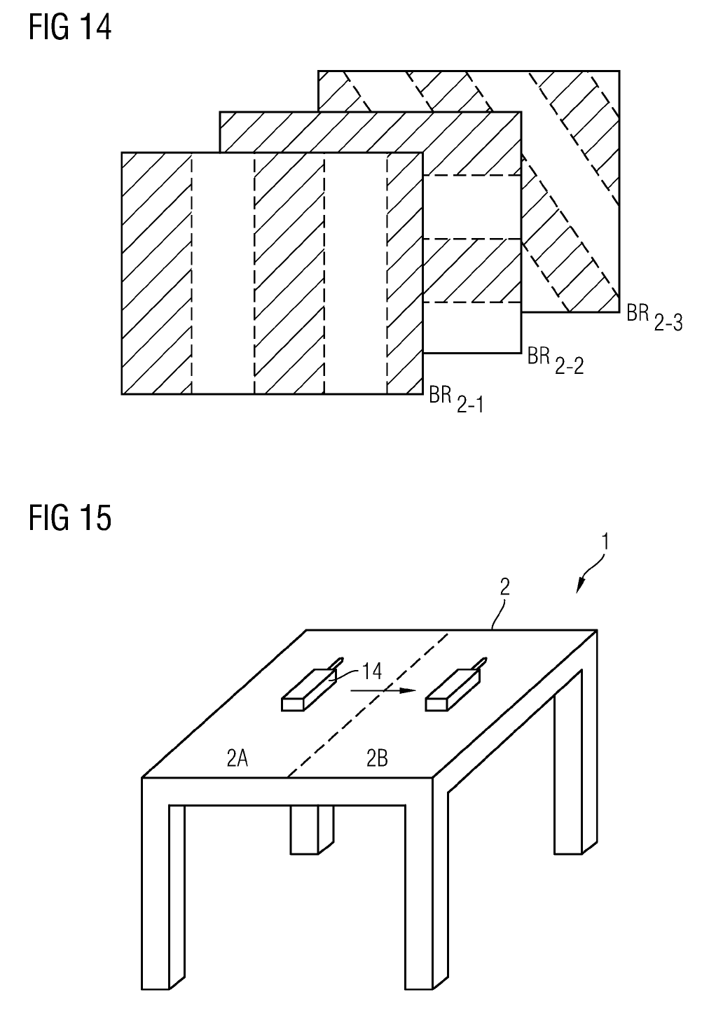

FIG. 15 shows an exemplary embodiment of the control device 1. In the simple exemplary application, the multidimensional reference space 2 is formed by a two-dimensional reference surface, this being the support surface of a table, for example. The two-dimensional table surface 2 is divided into two logical reference sub-spaces 2A, 2B, in which control elements 3 can be placed and shifted. In the embodiment illustrated in FIG. 15, the control element 3 is integrated in a corresponding appliance 14. In the exemplary application illustrated in FIG. 15, the appliance 14 consists of a mobile terminal, e.g. a mobile telephone. A control element 3 is integrated in the mobile terminal 14, wherein the position of the control element 3 or the associated terminal 14 can be detected by sensory means. For example, a function of the mobile terminal 14 is deactivated in the logical reference sub-space 2A while it is activated in the logical reference sub-space 2B. Switching between various functions or function groups of the appliance 14 can also be achieved by moving the appliance from the surface 2A to the surface 2B. For example, a mobile terminal 14 only accepts private telephone calls when it is in the region 2A, while the mobile terminal accepts business telephone calls when it is placed in the logical reference sub-space 2B.

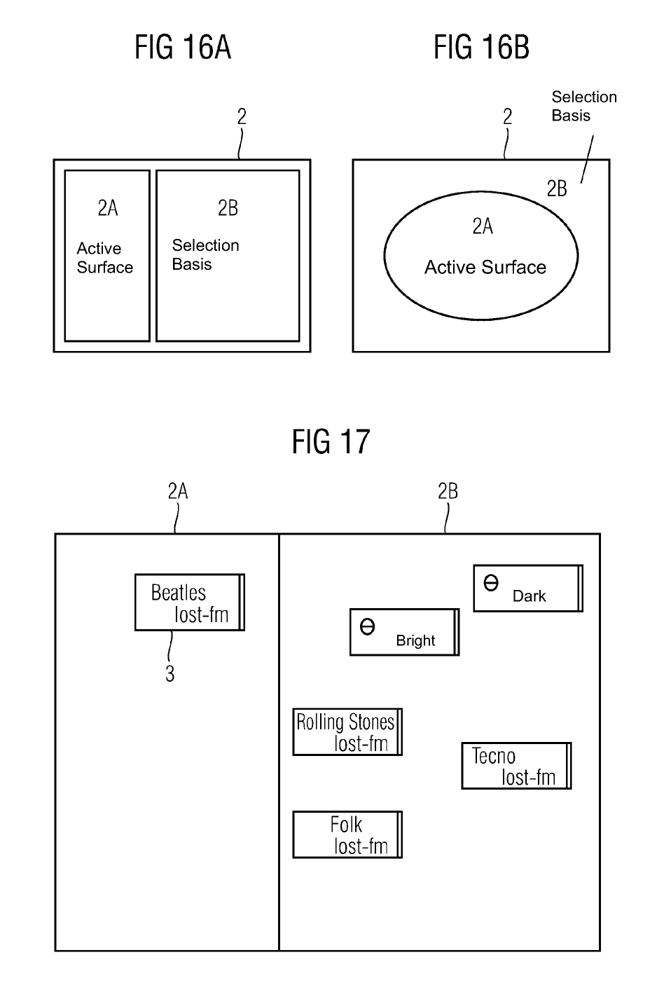

FIGS. 16A, 16B show further exemplary applications of the control device 1. In the example illustrated in FIG. 16, the reference space 2 is a two-dimensional surface comprising an active surface as a first logical reference sub-space 2A and a passive surface as a second logical reference sub-space 2B (e.g. forming a basis for selection). FIG. 16B shows an alternative arrangement of the two surfaces 2A, 2B. In the context of the exemplary application, control elements 3 are represented as tags on a graphical surface or a screen, and can be operated manually. The control elements 3 can be identified by means of a keyword in the manner of a small note. At the outset, the control elements 3 can be visually represented as a basic set that is available. In order to activate the associated actuators 5 or functions F, the user shifts the control elements 3 from the passive surface 2B to the active surface 2A. The user can move the control elements 3 freely back and forth between the two areas or surfaces 2A, 2B. The selection of one or more control elements 3 can be managed variously in this way. Depending on the surface 2A, 2B which the control elements 3 or tags are situated on, they count as active or inactive.

In addition to the placement of a control element 3 within the active area 2A itself, it is optionally also possible to analyze the position of the control element 3 there. For example, it is possible to define a sequence of selected control elements 3, indicating which control element 3 is shifted onto the active surface first. For example, the relative position of the control element within the active surface 2A can also be taken into consideration. In the example illustrated in FIG. 16A, a sequence from bottom right to top left is defined, for example. In the example illustrated in FIG. 16B, a sequence of the control elements can be defined depending on the distance from midpoint of the surface. In this embodiment, associated functions F or actuators 5 of the system are executed sequentially depending on a position which is determined on the basis of the position of the control element 3. The control elements 3 are visualized as tags and can be activated or deactivated as a result of being simply shifted by the user. A simple manual or haptic and intuitive control is therefore available to the user. At the same time, the user can immediately see which control elements 3 are currently activated or deactivated.

FIG. 17 shows an exemplary application of the control device 1. A tag “Beatles” is situated in an active area or active reference sub-space 2A, while the basic set of further inactive control elements is arranged in a passive reference sub-space 2B. The tags arranged there designate e.g. a music group such as “Rolling Stones”, music genres such as e.g. “Techno” or “Folk”, and light settings such as e.g. “bright” and “dark”. In the embodiment illustrated in FIG. 17, therefore, the control elements 3 are not assigned various actuators 5, but various attributes or functions F.

In the case of the control device 1 according to various embodiments, each control element 3 or each tag can be associated with any desired function F, any desired actuator 5, or any desired attribute. The control element 3 can also be associated with an address or a network path or reference information. The symbolic representation of a tag or a control element 3 can differ depending on source, type or service offered. The symbolic representation of the control elements 3 on a two-dimensional screen can feature various coloring or various icons and graphics depending on the associated unit.

The control elements 3 can be various types of tags, e.g. so-called placeholder tags, mnemonic tags or locator tags. In the case of placeholder tags or placeholders, the control element 3 itself carries the information, e.g. a keyword. Even complex information can be combined and hidden behind a control element 3 or a tag. Said information might be e.g. combined settings or configurations or programs. These settings be represented e.g. as a mnemonic tag or a mnemonic control element 3 in the reference space 2. Furthermore, reference information or a network address to a destination entity at a linked location can be represented by locator tags or localization control elements 3 in the reference space 2.

In a possible application, provision is made for a digital image frame which is connected to a network, in particular a local network. Said digital image frame is equipped with a touch-sensitive display in this case. If a user touches the display or approaches the display, tags or control elements 3 can be used to display various available media content, for example. These control tags 3 show e.g. photographs, images, etc. as media content. In addition, the control elements 3 can also display other media playback facilities in the network, e.g. music playlists, television transmitters, etc. Depending on which control elements 3 are placed in an active reference sub-space 2A, the content of the digital image frame or the media that is played back by the other facilities can change.

The control device 1 according to various embodiments is suitable for the widest variety of application scenarios and for controlling the widest variety of appliances in any environment. For example, the control device 1 according to various embodiments can be installed in mobile terminals, automatic merchandising terminals, control processors, etc. The control device 1 according to various embodiments is suitable for e.g. PDAs, mobile telephones or laptops. Using the control element 1 according to various embodiments, a multiplicity of appliances can be controlled or regulated simultaneously in a plurality of dimensions. It is also possible to realize fuzzy states in this case, since continuous placement offers a corresponding modeling possibility. The control elements 3 of the control device 1 according to various embodiments can represent groups of appliances simultaneously, said groups having any degree of complexity. Furthermore, the absolute position or relative proximity of the control elements 3 among themselves can be used as additional control information or regulating information. The surface or shape of the reference space 2 is unlimited. The control elements 3 that are used can be passive or active in their implementation. The control device 1 according to various embodiments is also suitable in particular for harsh environmental conditions within factory halls, public spaces, etc. In a possible embodiment, the control device 1 is integrated in everyday objects or appliances.

The surface of the reference space 2 can be enhanced in any way with additional control information including semantic meaning. Continuous positions can be transformed into discrete positions by means of grid patterns on the reference space 2. Moreover, the surface of the reference space 2 also allows information to be displayed in an adaptive manner. Since any number of control elements 3 can be added, the control device 1 according to various embodiments can easily be expanded, and allows simultaneous control of a multiplicity of functions F of various technical appliances. The control device 1 according to various embodiments additionally offers a wide diversity of possibilities for interaction with the control elements 3 that are displayed, wherein a plurality of parameters or functions F of an appliance can be controlled or regulated simultaneously. The control device 1 according to various embodiments allows the user to understand quickly and intuitively a multiplicity of controllable functions F of various appliances. The control device 1 according to various embodiments can therefore be utilized with particular ease by a user.

What is claimed is:

1. A control device for controlling a system comprising at least one manually operable control element, wherein a function of the system is controlled depending on a position of the control element in a multidimensional reference space.

2. The control device according to claim 1, wherein the multidimensional reference space is a two-dimensional reference surface.

3. The control device according to claim 1, wherein the position of the control element is formed by an absolute position of the control element in the reference space or a relative position of the control element to a reference point within the reference space, or by a relative position of the control element to at least one other control element within the reference space.

4. The control device according to claim 1, wherein the control element in the multidimensional reference space is graphically represented for its manual operation.

5. The control device according to claim 1, wherein the control element is a manually operable three-dimensional body, which is manually operable in the multidimensional reference space.

6. The control device according to claim 5, wherein the three-dimensional body is manually operable on a two-dimensional reference surface.

7. The control device according to claim 1, wherein at least one associated actuator or one associated actuator group can be controlled by the manually operable control element.

8. The control device according to claim 7, wherein the actuator can be controlled depending on the position of the control element in the multidimensional reference space.

9. The control device according to claim 1, wherein a plurality of control elements which touch each other in the multidimensional reference space can be linked together.

10. The control device according to claim 2, wherein the two-dimensional reference surface is formed by a sensor mat.

11. The control device according to claim 10, wherein the sensor mat is pressure-sensitive.

12. The control device according to claim 11, wherein the control element is a magnetic head.

13. The control device according to claim 2, wherein the two-dimensional reference surface is a touch-sensitive screen, on which the control element is operable as a graphical representation.

14. The control device according to claim 1, wherein the manual operation of the control element causes an absolute or relative position of the control element to be changed.

15. The control device according to claim 14, wherein the manual operation of the control element causes a pressure or a rotary movement to be applied to the control element.

16. The control device according to claim 14, wherein the manual operation of the control element causes an absolute or relative orientation of the control element to be changed in the reference space.

17. The control device according to claim 14, wherein the manual operation of the control element causes the control element to be rotated.

18. The control device according to claim 1, wherein each control element features a relevant control element identification.

19. The control device according to claim 1, wherein the multidimensional reference space comprises various logical reference sub-spaces, to which at least one function of the system is assigned in each case.

20. The control device according to claim 19, wherein the logical reference sub-spaces are formed by geometric partitions.

21. The control device according to claim 19, wherein the logical reference sub-spaces can be selected from a group of predefined reference sub-spaces.

22. The control device according to claim 19, wherein the logical reference sub-spaces can be changed relative to time.

23. The control device according to claim 19, wherein a real space is assigned to each logical reference sub-space.

24. The control device according to claim 19, wherein a switched state of the control element is assigned to each logical reference sub-space.

25. The control device according to claim 19, wherein the multidimensional reference space is a two-dimensional reference surface which features an active surface as a first logical reference sub-space, all control elements situated therein activating an associated actuator in each case, and a passive surface as a second logical reference sub-space, all control elements situated therein deactivating an associated actuator in each case.

26. The control device according to claim 19, wherein the logical reference sub-spaces can be changed depending on environmental conditions which are detected by sensory means.

27. The control device according to claim 1, wherein the position of the control element in the multidimensional reference space is detected by sensory means.

28. A method for controlling a system, comprising the step of contorlling a function of the system depending on the position of a manually operable control element in a multidimensional reference space.

29. The method according to claim 28, wherein the function of the system is controlled depending on an absolute position of the control element in the multidimensional reference space.

30. The method according to claim 28, wherein the function of the system is controlled depending on a relative position of the control element to a reference point within the multidimensional reference space.

31. The method according to claim 28, wherein the function of the system is controlled depending on a relative position of the control element to at least one other control element within the same or within another multidimensional reference space.

32. The method according to claim 28, wherein an associated actuator is controlled by the control element.

33. The method according to claim 28, wherein the control element is touched by a finger of a user for the purpose of its manual operation.

34. An appliance in which an appliance function is controlled depending on a position of a manually operable control element in a multidimensional reference space.

35. The appliance according to claim 34, comprising a touch-sensitive screen on which at least one manually operable control element is graphically represented, wherein a position of the control element in the multidimensional reference space can be changed after touching the graphically represented control element for controlling the appliance function.
